(19) United States
(12) Patent Application Publication
(10) Pub. No.: US 2005/0042540 A1
(43) Pub. Date: Feb. 24, 2005

(54) Positive resist composition and method of forming resist pattern

(75) Inventors: Waki Okubo, Kawasaki-shi (JP); Mitsuo Hagihara, Kawasaki-shi (JP); Kazuyuki Nitta, Kawasaki-shi (JP)

Correspondence Address: JOHN W. RYAN;C/O DECHERT LLP, PRINCETON PIKE CORPORATION CENTER, P.O. BOX 5218, PRINCETON, NJ, 08543-5218, US

(73) Assignee: Tokyo Ohka Kogyo Co., Ltd.

(21) Appl. No.: 10/859,904

(22) Filed: Jun. 2, 2004

(30) Foreign Application Priority Data
Jun. 6, 2003 (JP) P 2003-162059

(51) Int. Cl. G03C 1/76

(52) U.S. Cl. 430/270.1

(57) ABSTRACT

A positive resist composition capable of improving the occurrence of standing waves on the side walls of a resist pattern, and a method of forming a resist pattern that uses such a positive resist composition. The positive resist composition comprises a resin component (A) that displays improved alkali solubility under the action of acid, and a photoacid generator component (B) that generates acid on exposure, wherein the component (A) comprises a structural unit (a1) derived from hydroxystyrene, and a structural unit (a2) derived from a (meth)acrylate ester represented by a general formula (I) shown below, and the component (B) comprises a diazomethane based photoacid generator as the primary component.

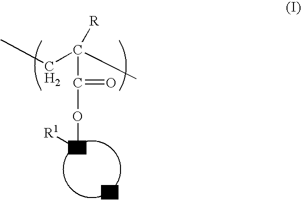

### BACKGROUND OF THE INVENTION

1. Field of the Invention

The present invention relates to positive resist composition and a method of forming a resist pattern.

Priority is claimed on Japanese Patent Application No. 2003-162059, filed Jun. 6, 2003, the content of which is incorporated herein by reference.

2. Description of Related Art

In recent years, in the production of semiconductor elements and liquid crystal display elements, advances in lithography techniques have lead to rapid progress in the field of miniaturization. Typically, these miniaturization techniques involve shortening of the wavelength of the exposure light source. Until recently, ultraviolet radiation such as g-lines and i-lines have been used as the exposure light source, but recently, mass production using KrF excimer lasers (248 nm) has been started, and even ArF excimer lasers (193 nm) are now starting to be introduced. Radiation of even shorter wavelengths such as F₂ excimer lasers (157 nm), EUV (extreme ultraviolet radiation), electron beams, X-rays and soft X-rays is also being investigated.

One example of a known resist that satisfies the high resolution requirements needed to reproduce a pattern with very minute dimensions is a chemically amplified resist composition comprising a base resin that displays increased alkali solubility under the action of acid, and a photoacid generator (hereafter abbreviated as PAG) that generates acid on exposure, dissolved in an organic solvent.

In KrF excimer laser lithography, polyhydroxystyrene resins in which a portion of the hydroxyl groups of the polyhydroxystyrene have been protected with an acid dissociable, dissolution inhibiting group (hereafter referred to as a PHS protective group resin) are typically used as the base resin component as they display high transparency relative to KrF excimer laser radiation (for example, see patent reference 1). Examples of the most commonly used acid dissociable, dissolution inhibiting groups include so-called acetal groups, including straight chain ether groups such as 1-ethoxyethyl groups and cyclic ether groups such as tetrahydropyranyl groups, as well as tertiary alkyl groups such as tert-butyl groups, and tertiary alkoxycarbonyl groups such as tert-butoxycarbonyl groups.

However, these PHS protective group resins display only a small change in solubility in the developing liquid between the state prior to dissociation of the acid dissociable, dissolution inhibiting groups and the state following dissociation, and have consequently been unable to adequately satisfy the demands associated with recent resist pattern miniaturization.

On the other hand, the use of copolymers of hydroxystyrene and a (meth)acrylate ester in which the carboxyl group of a (meth)acrylic acid has been protected with an acid dissociable, dissolution inhibiting group (hereafter, these copolymers are referred to as acrylic protective group resins) as the base resin has also recently been proposed (for example, see patent reference 2). In these copolymers, when the action of acid causes the acid dissociable, dissolution inhibiting groups to dissociate, a carboxylic acid is also generated, meaning the solubility in an alkali developing liquid is high, and the change in solubility of the composition in the developing liquid between the state prior to dissociation of the acid dissociable, dissolution inhibiting groups and the state following dissociation is large, thus enabling higher levels of miniaturization to be achieved.

Conventional PAGs can be broadly classified as either onium salts, including iodonium salts and sulfonium salts containing a fluoroalkylsulfonate as the anion, diazomethane based PAGs, or oxime based PAGs. Of these, onium salts offer an advantage in that they generate a stronger acid than that generated by either diazomethane based PAGs, or oxime based PAGs, thus enabling a more efficient dissociation of the acid dissociable, dissolution inhibiting groups.

The acid dissociable, dissolution inhibiting groups in acrylic protective group resins are known to more difficult to dissociate than those in PHS protective group resins.

Accordingly, onium salts are preferably used with acrylic protective group resins. Furthermore, compositions that use a mixed photoacid generator comprising an equal weight of an onium salt and a diazomethane based PAG with an acrylic protective group resin have also been reported (for example, see patent references 3 and 4).

(Patent Reference 1)

Japanese Unexamined Patent Application, First Publication No. Hei 4-211258

(Patent Reference 2)

Japanese Unexamined Patent Application, First Publication No. Hei 5-113667

(Patent Reference 3)

Japanese Unexamined Patent Application, First Publication No. 2002-287362

(Patent Reference 4)

Japanese Unexamined Patent Application, First Publication No. 2002-287363

However, when a resist pattern is formed using a composition comprising this type of acrylic protective group resin, together with a PAG containing either an onium salt or a mixture of an onium salt and a diazomethane based PAG, standing waves (hereafter abbreviated as SW) with an undulating surface are generated on the side walls of the product resist pattern, and pattern collapse can also be a problem.

### SUMMARY OF THE INVENTION

An object of the present invention is to provide a positive resist composition that displays superior fine resolution and enables improvement in both the occurrence of SW on the resist pattern side walls, and the likelihood of pattern collapse, as well as a method of forming a resist pattern using such a positive resist composition.

As a result of intensive research, the inventors of the present invention discovered that in a structural unit derived from a (meth)acrylate ester represented by a general formula (I) shown below, in those cases where R¹ is a methyl group, if the resin is combined with a diazomethane based PAQ achieving dissociation of the acid dissociable, dissolution inhibiting groups is difficult, meaning a resist pattern cannot be formed. Furthermore, they also discovered that in those cases where R¹ is a lower alkyl group of 2 or more carbon atoms, if the resin is combined with an onium salt or a mixture of an onium salt containing up to an equal quantity of a diazomethane based PAG, the level of improvement in the occurrence of SW is unsatisfactory. Based on these findings, the inventors determined that a positive resist composition comprising a base resin containing specific structural units, together with a PAG containing a diazomethane based PAG as the primary component, was able to resolve the problems described above, and they were hence able to complete the present invention.

In other words, a first aspect of the present invention provides a positive resist composition comprising a resin component (A) that displays improved alkali solubility under the action of acid, and a photoacid generator component (B) that generates acid on exposure, wherein the component (A) comprises a structural unit (a1) derived from hydroxystyrene, and a structural unit (a2) derived from a (meth)acrylate ester represented by a general formula (I) shown below: 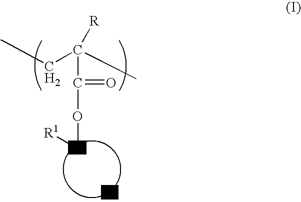
[wherein, R represents a hydrogen atom or a methyl group; R¹ represents a lower alkyl group of 2 or more carbon atoms; and X represents a group that, together with the adjacent carbon atom, forms a monocyclic or polycyclic aliphatic hydrocarbon group], and the component (B) comprises a diazomethane based photoacid generator as the primary component.

Furthermore, a second aspect of the present invention provides a method of forming a resist pattern comprising the steps of forming a positive resist film on a substrate using the positive resist composition described above, performing selective exposure of the positive resist film, and then performing alkali developing to form a resist pattern.

In this description, the term “(meth)acrylate” is used as a generic term meaning both methacrylate and acrylate. The term “structural unit” refers to a monomer unit that contributes to the formation of a polymer.

### DETAILED DESCRIPTION OF THE INVENTION

As follows is a more detailed description of the present invention.

<<Positive Resist Composition>>

A positive resist composition of the present invention comprises a resin (A) (hereafter referred to as the component (A)) that displays improved alkali solubility under the action of acid, and a photoacid generator (B) (hereafter referred to as the component (B)) that generates acid on exposure.

A positive resist composition of the present invention is characterized by a combination of a component (A) comprising specific structural units, and a component (B) comprising a diazomethane based PAG as the primary component.

<Component (A)>

First is a description of the component (A).

In the component (A), when acid is generated from the component (B) on exposure, the acid dissociable, dissolution inhibiting groups within the component (A) dissociate, causing the entire component (A) to change from an alkali insoluble state to an alkali soluble state. As a result, when a resist is exposed through a mask pattern during the formation of a resist pattern, or alternatively, is exposed and then subjected to a post exposure baking treatment, the exposed portions of the resist shift from an alkali insoluble state to an alkali soluble state, whereas the unexposed portions remain insoluble in alkali, meaning that alkali developing can then be used to form a positive resist pattern.

In the present invention, the component (A) comprises a structural unit (a1) derived from hydroxystyrene, and a structural unit (a2) derived from a (meth)acrylate ester represented by a general formula (I) shown above.

In addition to the structural unit (a1) and the structural unit (a2), the component (A) may also comprise a structural unit (a3) derived from styrene and represented by a general formula (II) shown below: 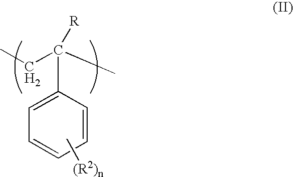
[wherein, R represents a hydrogen atom or a methyl group; R² represents a lower alkyl group; and n represents either 0, or an integer from 1 to 3].
[Structural Unit (a1)]

The structural unit (a1) is a structural unit derived from hydroxystyrene, and can be represented by a general formula (III) shown below. In this description the name hydroxystyrene describes both the literal hydroxystyrene, as well as α-methylhydroxystyrene.

In the structural unit (a1) represented by the general formula (III) shown below, the bonding position of the hydroxyl group may be the o-position, the m-position or the p-position, although from the viewpoints of availability and cost, the p-position is preferred. 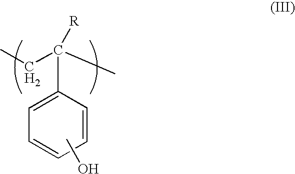
(wherein, R represents a hydrogen atom or a methyl group)

The structural unit (a1) preferably accounts for 55 to 95 mol %, and even more preferably from 65 to 90 mol % of the component (A). Ensuring that the proportion of the structural unit (a1) is at least 55 mol % enables a resist pattern with high contrast to be obtained, whereas ensuring that the proportion is no more than 95 mol % enables film thinning during developing to be suppressed.

[Structural Unit (a2)]

The structural unit (a2) is a structural unit derived from a (meth)acrylate ester represented by the general formula (I) shown above. In the structural unit (a2), the ester portion, namely the section comprising the groups R¹ and X, and the carbon atom adjacent to X, functions as an acid dissociable, dissolution inhibiting group.

In the formula (I), R represents either a hydrogen atom or a methyl group.

The group R¹ represents a straight chain, branched chain or cyclic lower alkyl group of 2 or more, and preferably from 2 to 6, and even more preferably from 2 to 4, carbon atoms. By ensuring that the number of carbon atoms within the alkyl group is at least 2, the acid dissociable, dissolution inhibiting group can be adequately dissociated even by the comparatively weak acid generated by a diazomethane based PAG, thus enabling pattern formation to proceed. As described above, in the case of a methyl group, the acid dissociable, dissolution inhibiting group does not dissociate adequately, meaning pattern formation is impossible.

The group X represents a group that, together with the adjacent carbon atom, forms a monocyclic or polycyclic aliphatic hydrocarbon group. Examples of this aliphatic hydrocarbon group include groups in which one hydrogen atom has been removed from a cycloalkane, a bicycloalkane, a tricycloalkane or a tetracycloalkane. Specific examples include groups in which one hydrogen atom has been removed from either a monocyclic cycloalkane such as cyclohexane, or from a polycyclic cycloalkane such as adamantane, norbornane, isobornane, tricyclodecane or tetracyclododecane. This aliphatic hydrocarbon group can be appropriately selected from the multitude of groups proposed for use with KrF and ArF resists. Of these groups, a cyclohexyl group, adamantyl group, norbornyl group or tetracyclododecanyl group is preferred, and an adamantyl group is the most desirable, as it provides particularly superior dry etching resistance when the thickness of the resist is reduced.

In a positive resist composition of the present invention, by incorporating the structural unit (a2) within the component (A), the component (A) is able to be combined with a diazomethane based PAG. As a result, the appearance of SW (standing waves) in a resist pattern produced using the positive resist composition can be improved.

Furthermore, in the present invention, by incorporating a structural unit (a2) derived from a (meth)acrylate ester within the component (A), the composition displays superior transmittance of KrF excimer laser radiation than a composition containing a conventional polyhydroxystyrene based resin.

In addition, because the component (A) of a positive resist composition of the present invention comprises a structural unit (a2) containing the type of aliphatic hydrocarbon group described above, the composition also displays excellent dry etching resistance relative to CFx based gases.

Furthermore in the component (A) of the present invention, the structural unit (a2) derived from a (meth)acrylate ester contains the acid dissociable, dissolution inhibiting group, and consequently in comparison with conventional resins in which the hydroxyl groups of a polyhydroxystyrene are protected with acid dissociable, dissolution inhibiting groups, the solubility of the resin in the alkali developing liquid following dissociation of the acid dissociable, dissolution inhibiting groups, that is, the maximum solubility rate (Rₘₐₓ), is increased.

Specific examples of the acid dissociable, dissolution inhibiting group comprising the groups R¹ and X, and the carbon atom adjacent to X, include a 2-ethyl-cyclohexyl group and a 2-ethyl-2-adamantyl group.

The structural unit (a2) preferably accounts for 5 to 40 mol %, and even more preferably from 7 to 38 mol % of the component (A). Ensuring that the proportion of the structural unit (a2) is at least 5 mol % enables the dry etching resistance to be improved, whereas ensuring that the proportion is no more than 40 mol % enables the production of a resist pattern with a favorable rectangular shape.

In the component (A), the molar ratio between the structural units (a1) and the structural units (a2) is preferably within a range from 65:35 to 90:10. If the proportion of the structural units (a2) is greater than this range, then the solubility of the composition in the developing liquid tends to be inadequate, whereas if the proportion of the structural units (a2) is too low, then there is a danger that the effects provided by including the structural unit (a2) will not manifest adequately.

Furthermore, the combined total of the structural units (a1) and the structural units (a2) preferably accounts for at least 70 mol % of all the structural units within the component (A). If the proportion is lower than 70 mol %, then the resolution tends to deteriorate. The combined total of the structural units (a1) and the structural units (a2) is even more preferably 90 mol % or higher, and may even be 100 mol %.

[Structural Unit (a3)]

The structural unit (a3) is a structural unit derived from styrene and represented by the general formula (II) shown above. Here, the name styrene describes both the literal styrene, as well as α-methylstyrene.

The lower alkyl group of the group R² may comprise either a straight chain or a branched chain, and the number of carbon atoms is preferably from 1 to 5.

The subscript n represents either 0, or an integer from 1 to 3, although 0 is preferred.

In those case where n represents an integer from 1 to 3, the bonding position of the R group may be the o-position, the m-position or the p-position, although from the viewpoints of availability and cost, the p-position is preferred.

In the present invention, the structural unit (a3) is not essential, although inclusion of the structural unit (a3) offers various advantages, including an improvement in the dry etching resistance relative to CFx based gases and the like, and an improvement in the line edge roughness of the generated resist pattern, thus enabling an improvement in resolution.

If used, the structural unit (a3) preferably accounts for 3 to 30 mol %, and even more preferably from 5 to 10 mol % of all the structural units within the component (A). Ensuring that the proportion of the structural unit (a3) is at least 3 mol % enables an improvement in resolution to be realized, whereas ensuring that the proportion is no more than 30 mol % produces a better balance with the other structural units.

[Structural Unit (a4)]

The resin may also contain an optional structural unit (a4) that is different from the aforementioned structural units (a1) to (a3), provided the inclusion of this optional structural unit does not impair the effects of the present invention.

There are no particular restrictions on the structural unit (a4), provided it cannot be classified as one of the above structural units (a1) to (a3), and any of the structural units proposed as suitable units for use within the base resins used in a conventional chemically amplified KrF positive resist compositions or ArF positive resist compositions can be used, in accordance with the particular exposure light source used during the resist pattern formation. Examples of such structural units include structural units derived from (meth)acrylate esters that contain a polycyclic group.

The structural units of the component (A) are combined by selecting appropriate structural units (a2) to (a4) in accordance with the target application, and combining these units with the structural unit (a1). Components that contain all of the structural units (a1) to (a3) are preferred as they offer a large improvement in SW, as well as displaying excellent dry etching resistance, resolution, and adhesion between the resist film and the substrate. Depending on the target application, structural units other than the structural units (a1) to (a4) may also be used.

In the case of a binary polymer of structural units (a1) and (a2), polymers in which the structural unit (a1) accounts for 60 to 95 mol %, and preferably from 65 to 85 mol % of all the structural units, and the structural unit (a2) accounts for 5 to 40 mol %, and preferably from 15 to 35 mol %, are preferred in terms of the ease with which the resin synthesis can be controlled.

Furthermore, in the case of a ternary system that further comprises a structural unit (a3), polymers in which the structural unit (a1) accounts for 60 to 90 mol %, and preferably from 70 to 85 mol % of all the structural units, the structural unit (a2) accounts for 5 to 20 mol %, and preferably from 10 to 20 mol %, and the structural unit (a3) accounts for 5 to 20 mol %, and preferably from 5 to 10 mol % offer superior etching resistance, resolution, adhesion, and resist pattern shape, and are consequently preferred.

More specifically, from the viewpoints of ensuring a favorable resolution and resist pattern shape, a copolymer (i) or (ii) described below is preferred as the aforementioned resin (A).

Copolymer (i): a copolymer comprising a structural unit (a1) and a structural unit (a2).

Copolymer (ii): a copolymer comprising a structural unit (a1), a structural unit (a2), and a structural unit (a3).

The weight average molecular weight (Mw: the polystyrene equivalent value determined by gel permeation chromatography, this also applies to all subsequent molecular weight values) of the component (A) is preferably within a range from 3000 to 50,000, and even more preferably from 8000 to 25,000. Ensuring a Mw value of at least 3000 enables a resist with excellent dry etching resistance and heat resistance to be obtained. Furthermore, ensuring a Mw value of no more than 25,000 enables suppression of negativity and improves the dissolution in solvent.

Furthermore, a monodisperse component (A) in which the polydispersity (Mw/Mn ratio) prior to protection of a portion of the hydroxyl groups with the acid dissociable, dissolution inhibiting group is relatively small, provides better resolution and is consequently preferred. Specifically, the Mw/Mn ratio is preferably no more than 2.5, and even more preferably within a range from 1.5 to 2.2.

The component (A) can be produced using the methods disclosed in the patent references mentioned above. Specifically, first a monomer corresponding with the structural unit (a2) is prepared, and this monomer is then copolymerized, using a conventional radical polymerization or the like, with a monomer precursor corresponding with the structural unit (a1) (for example, acetoxystyrene), and where necessary other optional monomers of the structural unit (a3) or the like, in the presence of a radical polymerization initiator such as azobisisobutyronitrile (AIBN) or azobis(2-methylpropionate), thus producing a copolymer, and the above precursor sections within this copolymer are then converted to hydroxystyrene units, thus completing production of the component (A).

The quantity of the component (A) within a positive resist composition of the present invention can be adjusted in accordance with the thickness of the resist film that is desired. Typically, the quantity of the component (A), expressed as a solid fraction concentration, is within a range from 5 to 25% by weight, and preferably from 8 to 20% by weight.

<Component (B)>

In the present invention, the component (B) is a PAG comprising a diazomethane based photoacid generator as the primary component.

The term “as the primary component” means that of the component (B) contained within a positive resist composition of the present invention, the diazomethane based PAG accounts for at least 50% by weight, and preferably at least 55% by weight, and even more preferably 80% by weight or more, and most preferably 100% by weight.

In the present invention, because the component (B) contains, as its primary component, a diazomethane based PAG, which generates a weaker acid than an onium salt, the composition is less prone to contamination by amines or the like from the surrounding environment, and is less likely to be affected by nitrogen containing components such as nitride films provided on the substrate. As a result, a significant improvement is achieved in terms of environmental dependency problems and substrate dependency problems, as the PAG is less prone to reaction with nitrogen containing components from the atmosphere or the substrate during storage, which can cause a loss of activity.

As the diazomethane based PAG, any of the conventionally used compounds can be used, although in terms of ensuring favorable transparency, an appropriate level of acid strength, and good alkali solubility, the use of bisalkylsulfonyldiazomethanes represented by the general formula (IV) shown below is particularly preferred.

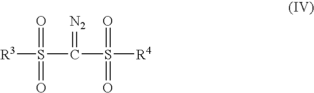

In the formula (IV), R³ and R⁴ each represent, independently, a branched or cyclic alkyl group or aryl group of 3 to 8, and preferably 4 to 7, carbon atoms. Specific examples of R³ and R⁴ include tert-butyl groups, cyclohexyl groups and phenyl groups, and of these, cyclohexyl groups are particularly preferred as they offer even better improvement of the resist pattern SW, and also provide a favorable improvement in the resolution. It is surmised that the reason for this finding is that because cyclohexyl groups are very bulky groups, the generated acid finds it more difficult to disperse through the resist.

Specific examples of suitable bisalkylsulfonyldiazomethanes include bisalkylsulfonyldiazomethanes with straight chain or branched alkyl groups of 1 to 4 carbon atoms, such as bis(n-propylsulfonyl)diazomethane, bis(isopropylsulfonyl)diazomethane, bis(n-butylsulfonyl)diazomethane, bis(isobutylsulfonyl)diazomethane, and bis(tert-butylsulfonyl)diazomethane; bisalkylsulfonyldiazomethanes with cyclic alkyl groups of 5 to 6 carbon atoms, such as bis(cyclopentylsulfonyl)diazomethane and bis(cyclohexylsulfonyl)diazomethane; and bisarylsulfonyldiazomethanes with aryl groups, such as bis(p-toluenesulfonyl)diazomethane and bis(2,4-dimethylphenylsulfonyl)diazomethane. Of these, bis(cyclohexylsulfonyl)diazomethane provides a large improvement in SW and enables the production of a high resolution resist pattern, and is consequently preferred.

The compounds of the composition (B) can be used singularly, or in combinations of two or more different compounds.

The component (B) may also contain an additional conventional PAG, provided such addition does not impair the effects of the present invention. Of such conventional PAGs, onium salts and oxime based PAGs are preferred, and oxime based PAGs are particularly preferred as they generate a weaker acid than onium salts.

Examples of suitable oxime based PAGs include α-(methylsulfonyloxyimino)-phenylacetonitrile, α-(methylsulfonyloxyimino)-4-methoxyphenylacetonitrile, α-(trifluoromethylsulfonylox yimino)-4-methoxyphenylacetonitrile, α-(propylsulfonyloxyimino)-4-methylphenylaceto nitrile, α-(methylsulfonyloxyimino)-4-bromophenylacetonitrile, and the compound represented by the formula (V) shown below.

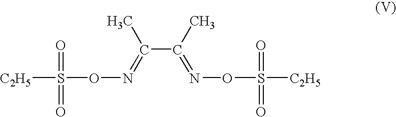

Examples of onium salts include diphenyliodonium trifluoromethanesulfonate or nonafluorobutanesulfonate; bis(4-tert-butylphenyl)iodonium trifluoromethanesulfonate or nonafluorobutanesulfonate; triphenylsulfonium trifluoromethanesulfonate or nonafluorobutanesulfonate; tri(4-tert-butylphenyl)sulfonium trifluoromethanesulfonate or nonafluorobutanesulfonate; dimethylmonophenylsulfonium trifluoromethanesulfonate or nonafluorobutanesulfonate; monomethyldiphenylsulfonium trifluoromethanesulfonate or nonafluorobutanesulfonate; and 4-tert-butoxycarbonylmethyloxyphenyldiphenylsulfonium trifluoromethanesulfonate or nonafluorobutanesulfonate.

The quantity of the component (B) is typically within a range from 1 to 20 parts by weight, and preferably from 2 to 10 parts by weight, per 100 parts by weight of the component (A). If the quantity is lower than the above range, then pattern formation does not progress satisfactorily, whereas if the quantity exceeds the above range it becomes difficult to achieve a uniform solution, and there is a danger of a deterioration in the storage stability of the composition.

<Other Components>

[Nitrogen Containing Organic Compound (C)]

In a positive resist composition of the present invention, in order to improve the resist pattern shape and the long term stability (post exposure stability of the latent image formed by the pattern wise exposure of the resist layer), a nitrogen containing organic compound can also be added as a separate, optional component. A multitude of these nitrogen containing organic compounds have already been proposed, and any of these known compounds can be used, although a secondary lower aliphatic amine or a tertiary lower aliphatic amine is preferred.

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and of these, alkanolamines such as triethanolamine are particularly preferred.

These compounds may be used singularly, or in combinations of two or more different compounds.

This amine is typically added in a quantity within a range from 0.01 to 2.0% by weight relative to the component (A).

[Organic Carboxylic Acid, or Phosphorus Oxo Acid or Derivative Thereof (D)]

Furthermore, in order to prevent any deterioration in sensitivity caused by the addition of the aforementioned component (C), and improve the resist pattern shape and the long term stability, an organic carboxylic acid, or a phosphorus oxo acid or derivative thereof can also be added as an optional component (D). Either one, or both of the component (C) and the component (D) can be used.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or derivatives thereof such as esters, including phosphoric acid, di-n-butyl phosphate and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred.

The component (D) is typically used in a quantity within a range from 0.01 to 5.0 parts by weight per 100 parts by weight of the component (A).

[Other Optional Components]

Other miscible additives can also be added to a positive resist composition of the present invention according to need, and examples include additive resins for improving the properties of the resist film, surfactants for improving the ease of application, dissolution inhibitors, plasticizers, stabilizers, colorants and halation prevention agents.

[Organic Solvent]

A positive resist composition according to the present invention can be produced by dissolving the essential components (A) and (B), together with any optional components such as the component (C), in an organic solvent.

The organic solvent may be any solvent capable of dissolving the various components to generate a uniform solution, and one or more solvents selected from known materials used as the solvents for conventional chemically amplified resists can be used.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methylpyruvate, ethyl pyruvate, methyl methoxypropionate, and ethyl ethoxypropionate. These organic solvents can be used singularly, or as a mixed solvent containing two or more different solvents.

The quantity of organic solvent used in a positive resist composition of the present invention is preferably sufficient to dissolve the solid fraction (the combination of the components (A) to (D), and any other optional components) and generate a solid fraction concentration within a range from 3 to 30% by weight, and even more preferably from 5 to 20% by weight.

A positive resist composition of the present invention displays particularly favorable transparency to KrF excimer laser radiation, and is consequently ideal for use in KrF excimer laser exposure processes, although it is also effective for other types of radiation of shorter wavelength such as ArF excimer lasers, F₂ excimer lasers, EUV (extreme ultraviolet radiation), VUV (vacuum ultraviolet radiation), electron beams, X-rays and soft X-rays.

<<Method of Forming a Resist Pattern>>

A method of forming a resist pattern according to the present invention can be conducted in the manner described below, using an aforementioned positive resist composition of the present invention.

Namely, a resist composition of the present invention is first applied to the surface of a substrate such as a silicon wafer using a spinner or the like, and a prebake is then conducted under temperature conditions of 90 to 120° C. for 40 to 120 seconds, and preferably for 60 to 90 seconds, thereby forming a resist film. Following selective exposure of the resist film with a KrF excimer laser through a desired mask pattern using, for example, a KrF exposure apparatus, PEB (post exposure baking) is conducted under temperature conditions of 90 to 120° C. for 40 to 120 seconds, and preferably for 60 to 90 seconds.

Subsequently, developing is conducted using an alkali developing liquid such as an aqueous solution of tetramethylammonium hydroxide with a concentration of 0.05 to 10% by weight, and preferably from 0.05 to 3% by weight. A rinse treatment is then conducted to wash away and remove any developing liquid left on the surface of the substrate, together with those sections of the resist composition that have dissolved in the developing liquid, and the resist is then dried. An optional postbake may also be conducted if desired. In this manner, a resist pattern that is faithful to the mask pattern can be obtained.

Because a positive resist composition of the present invention uses a PAG that comprises a diazomethane based PAG as the primary component, the substrate dependency is low. As a result, there are no particular restrictions on the substrate, and any conventional substrate can be used. The present invention can also be applied to nitrogen containing substrates such as titanium nitride.

Examples of suitable conventional substrates include the types of substrates used for electronic componentry, including substrates with a predetermined wiring pattern formed thereon.

Specific examples of the substrate include silicon wafers, metal substrates such as copper, chrome, steel or aluminum, as well as other substrates such as glass.

Examples of suitable materials for the aforementioned wiring pattern include copper, solder, chrome, aluminum, nickel and gold.

An organic or inorganic anti-reflective film may also be provided between the substrate and the applied layer of the resist composition.

A thus obtained resist pattern displays a reduced occurrence of SW (standing waves).

The reason that the present invention provides an improvement in the generation of SW is not entirely clear, although the following explanation represents one possibility.

Namely, it is thought that a SW is usually generated during irradiation of the exposure light, as a result of the exposure light penetrating through the resist layer and reflecting off the substrate surface, thus generating a standing wave within the resist layer. The higher the transparency of the resist layer relative to the exposure light, the higher the incidence of SW generation. Accordingly, it is surmised that because resists that use the type of copolymer disclosed in the above patent references 2 and 3 (acrylic protective group resins) display a higher transparency relative to KrF excimer laser radiation than the polyhydroxystyrene based resins (PHS protective group resins) described above, the occurrence of SW is markedly higher.

Furthermore as described above, conventionally, acetal groups, tertiary alkyl groups or tertiary alkoxycarbonyl groups or the like are the most commonly used acid dissociable, dissolution inhibiting groups for the base resin, and of these, although acetal groups undergo dissociation in comparatively weak acid, such resins suffer from poor resistance to dry etching by CFx bases gases or the like, and as a result, tertiary alkyl groups are the most preferred. However, in those cases where a (meth)acrylate ester is formed, tertiary alkyl groups do not dissociate readily in weak acids, and so a strong acid must be used. Consequently, onium salts, which generate a strong acid and provide favorable sensitivity, are the most commonly used PAGs for combination with acrylic protective group resins.

However, because onium salts display a high sensitivity and generate a strong acid, they exhibit a powerful action. It is thought that this causes the compositions to be more prone to the effects of standing waves, resulting in the generation of larger SW. In contrast, because the present invention uses a combination of a resin with acid dissociable, dissolution inhibiting groups that will dissociate readily even in the presence of a sole diazomethane based PAG, and a PAG comprising a diazomethane based PAG as the primary component, the effects of standing waves can be reduced, enabling an improvement in SW occurrence.

Furthermore, in conventional resist compositions or layered products comprising a resist layer laminated on top of a substrate, the PAG is prone to environmental dependency problems, wherein during storage, the PAG reacts with amines within the surrounding atmosphere and loses activity, and it is known that this problem is particularly significant in those cases where onium salts that generate strong acids are used. However, in a positive resist composition of the present invention, because the PAG contains, as its primary component, a diazomethane based PAG that is resistant to reactions with amines, the environmental dependency is small. Furthermore, in those cases where a nitrogen containing substrate is used as the substrate, normally a substrate dependency problem exists, wherein the PAG loses activity, but in the present invention, this substrate dependency is also small.

In addition, in a positive resist composition according to the present invention, a resin comprising structural units derived from a (meth)acrylate ester (an acrylic protective group resin) is used as the base resin, and consequently a resist using such a positive resist composition displays less absorption of KrF excimer laser radiation, and offers greater transmittance than a resist using a conventional polyhydroxystyrene based resin (a PHS protective group resin).

Furthermore, the solubility in the alkali developing liquid of those regions of the resist in which the acid dissociable, dissolution inhibiting groups have dissociated as a result of exposure, that is, the maximum solubility rate (Rmax), is high, enabling an improvement in the contrast of the generated resist pattern. Moreover, the acid dissociable, dissolution inhibiting group used in the present invention comprises either a monocyclic or polycyclic hydrocarbon group, and consequently a resist can be obtained that displays excellent resistance to dry etching by CFx and the like.

### EXAMPLES

As follows is a more detailed description of the present invention, based on a series of test examples.

### Test Example 1

To 100 parts by weight samples of a copolymer of p-hydroxystyrene and 2-ethyl-2-adamantyl methacrylate (molar ratio 75:25, Mw=13,000, Mw/Mn=2.2) as the component (A) were added one of the B components (B-1) to (B-4) described below, 0.1 parts by weight of triethanolamine as the component (C), and 0.05 parts by weight of XR-104 (manufactured by Dainippon Ink and Chemicals, Inc.) as an activator, and each of the mixtures was dissolved in 825 parts by weight of ethyl lactate, thus yielding four positive resist compositions (1) to (4).
(B-1): 10 parts by weight of bis(cyclohexylsulfonyl)diazomethane
(B-2): 6 parts by weight of a mixture of bis(cyclohexylsulfonyl)diazomethane and triphenylsulfonium nonafluorobutanesulfonate (weight ratio=5:1)
(B-3): 3 parts by weight of a mixture of bis(cyclohexylsulfonyl)diazomethane and triphenylsulfonium nonafluorobutanesulfonate (weight ratio=1:1)
(B-4): 2 parts by weight of triphenylsulfonium nonafluorobutanesulfonate

Each of the positive resist compositions (1) to (4) obtained above was applied to a silicon wafer using a spinner, and was then prebaked and dried on a hotplate at 120° C. for 60 seconds, forming a resist layer with a film thickness of 420 nm.

Subsequently, this layer was irradiated with a KrF excimer laser (248 nm) through a binary mask, using a KrF stepper FPA3000EX3 (manufactured by Canon Inc., NA (numerical aperture)=0.6, σ=0.65). The irradiated resist was subjected to PEB treatment at 120° C. for 60 seconds, subsequently subjected to puddle development for 60 seconds at 23° C. in a 2.38% by weight aqueous solution of tetramethylammonium hydroxide, was then washed for 15 seconds with pure water, and finally, was subjected to a postbake at 100° C. for 60 seconds, thus forming a resist pattern.

As a result, a line and space pattern with a resist pattern size of 180 nm was formed from each composition.

Inspection of the state of the thus obtained resist patterns (including factors such as the occurrence of side wall SW or pattern collapse) using a critical dimension SEM revealed that in the resist patterns formed using the positive resist compositions (1) and (2) containing a diazomethane based PAG as the primary component, SW was almost non-existent. Furthermore, no pattern collapse was observed.

In contrast, in the resist patterns formed using the positive resist compositions (3) and (4) comprising a PAG containing at least 50% of an onium salt, marked SW was observed. Furthermore, some pattern collapse was also noted.

### Test Example 2

Using positive resist compositions (1) to (4) prepared in the same manner as the test example 1, the following operations were conducted.

First, substrates were prepared by layering an organic anti-reflective film (brand name DUV-44, manufactured by Brewer Science Ltd.) on top of a silicon wafer, and then heating at 205° C. to form a film of thickness 65 nm.

Subsequently, each of the positive resist compositions (1) to (4) was applied to the surface of a substrate using a spinner, and was then prebaked and dried on a hotplate at 120° C. for 60 seconds, forming a resist layer with a film thickness of 420 nm.

This layer was then irradiated with a KrF excimer laser (248 nm) through a 6% half tone (H.T.) mask, using a KrF stepper FPA3000EX3 (manufactured by Canon Inc., NA (numerical aperture)=0.68, ⅔ annular illumination). The irradiated resist was subjected to PEB treatment at 120° C. for 60 seconds, subsequently subjected to puddle development for 60 seconds at 23° C. in a 2.38% by weight aqueous solution of tetramethylammonium hydroxide, was then washed for 15 seconds with pure water, and finally, was subjected to a postbake at 100° C. for 60 seconds, thus forming a resist pattern.

As a result, a line and space pattern with a resist pattern size of 180 nm was formed from each composition. Furthermore, in a separate preparation using the same method, line and space patterns with a resist pattern size of 160 nm were also formed.

Inspection of the state of the thus obtained resist patterns using a critical dimension SEM revealed little difference from the test example 1 in which no anti-reflective film was provided, although the resist patterns formed using the positive resist compositions (1) and (2) containing a diazomethane based PAG as the primary component showed an improvement in the level of SW when compared with the resist patterns formed using the positive resist compositions (3) and (4). The difference in this SW effect was particularly marked for the 160 nm line and space patterns.

As described above, a positive resist composition of the present invention displays superior fine resolution, and produces a resist pattern that displays a reduced occurrence of SW and no pattern collapse.

1. A positive resist composition comprising a resin component (A) that displays improved alkali solubility under action of acid, and a photoacid generator component (B) that generates acid on exposure, wherein
said component (A) comprises a structural unit (a1) derived from hydroxystyrene, and a structural unit (a2) derived from a (meth)acrylate ester represented by a general formula (I) shown below: 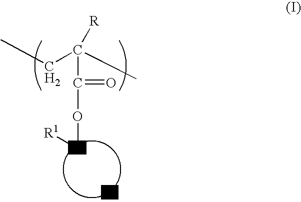
wherein, R represents a hydrogen atom or a methyl group; R¹ represents a lower alkyl group of 2 or more carbon atoms; and X represents a group that, together with an adjacent carbon atom, forms a monocyclic or polycyclic aliphatic hydrocarbon group,
and said component (B) comprises a diazomethane based photoacid generator as a primary component.

2. A positive resist composition according to claim 1, wherein said component (A) further comprises a structural unit (a3) derived from styrene and represented by a general formula (II) shown below: 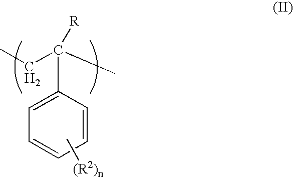
wherein, R represents a hydrogen atom or a methyl group; R² represents a lower alkyl group; and n represents either 0, or an integer from 1 to 3.

3. A positive resist composition according to claim 1, wherein said component (A) comprises a copolymer (A1) of said structural unit (a1) and said structural unit (a2).

4. A positive resist composition according to claim 2, wherein said component (A) comprises a copolymer (A2) of said structural unit (a1), said structural unit (a2), and said structural unit (a3).

5. A positive resist composition according to claim 1, wherein in said component (A), said structural unit (a2) is a structural unit derived from 2-ethyl-2-adamantyl (meth)acrylate.

6. A positive resist composition according to claim 1, wherein said component (B) further comprises an oxime based photoacid generator.

7. A positive resist composition according to claim 1, wherein said diazomethane based photoacid generator is bis(cycloalkylsulfonyl)diazomethane.

8. A positive resist composition according to claim 1, for use in a KrF excimer laser exposure process.

9. A positive resist composition according to claim 1, further comprising a nitrogen containing organic compound (C).

10. A method of forming a resist pattern comprising the steps of forming a positive resist film on a substrate using a positive resist composition according to any one of claim 1 through claim 9, performing selective exposure of said positive resist film, and performing alkali developing to form a resist pattern.
